(19) United States
(12) Patent Application Publication
(10) Pub. No.: US 2003/0002522 A1
(43) Pub. Date: Jan. 2, 2003

(54) CDMA digital receiver and automatic gain control method thereof

(76) Inventors: Woo-Sik Kim, Seoul (KR); Young-Chul Noh, Kyungki-do (KR)

Correspondence Address: FLESHNER & KIM, LLP, P.O. Box 221200, Chantilly, VA, 20153-1200, US

(21) Appl. No.: 10/142,948

(22) Filed: May 13, 2002

(30) Foreign Application Priority Data
May 14, 2001 (KR) 26192/2001

(51) Int. Cl. H04J 3/16

(52) U.S. Cl. 370/465; 370/441

(57) ABSTRACT

In a CDMA (code division multiple access) digital receiver and an automatic gain control method thereof, when an RF-processed CDMA analog IF (intermediate frequency) signal is inputted, the analog IF signal is converted into a digital IF signal. The digital IF signal is then digital-demodulated, and a digital-demodulated base band signal is clipped so as to have a level of a digital base band signal preset in a CDMA system. Accordingly it is possible to perform a digital demodulation in a CDMA receiver. In addition, it is possible to perform the same automatic gain control as a CDMA analog receiver by receiving the same input signal (analog IF signal) as the CDMA analog receiver. As a result, the performance of a CDMA receiver is significantly improved.

### BACKGROUND OF THE INVENTION

1. Field of the Invention

The present invention relates to a CDMA (code division multiple access) system, and in particular to a CDMA digital receiver and an automatic gain control method thereof.

2. Background of the Related Art

In a CDMA (code division multiple access) method, several users hold the same frequency band jointly, and each user is distinguished by a characteristic PN (pseudo noise) code of a suer communication channel. In a system using CDMA method, several users hold a frequency and time jointly, a different random pseudo sequence is allocated to each user, a transmission signal of each user is spreading-transmitted to a receiving side, and the receiving side restores the signal by de-spreading it by using the same PN (pseudo noise) sequence used in the transmitting side.

FIG. 1 illustrates a construction of a general CDMA system. As depicted in FIG. 1, a general CDMA system includes a MS (mobile station) 1 providing a mobile service to a mobile service subscriber, a BS (base station) 2 interfacing with the MS 1 by a CDMA method and a MSC (mobile switching center) 3 processing a call request transmitted from the BS 2.

The MS 1 and the BS 2 respectively include a RF (radio frequency) processing unit 1a, 2a performing a conversion function between a RF (radio frequency) and an IF (intermediate frequency), an IF processing unit 1b, 2b performing a conversion function between the IF signal and a base band signal, a BS (base band signal) processing unit 1c, 2c performing a conversion function between a base band analog signal and a digital signal, and a modem unit 1d, 2d controlling overall operations of the MS 1 and BS 2.

If a signal is transmitted from the MS 1 to the BS 2, when a modem unit 1d of the MS 1 generates a CDMA signal, the BS processing unit 1c converts the CDMA signal into a base band analog signal, the IF processing unit 1b converts the base band analog signal into an IF signal, and the RF processing unit 1a converts the IF signal into a RF signal and transmits it to the BS 2. The RF processing unit 2a of the BS 2 converts the RF signal received from the MS 1 into an IF signal, the IF processing unit 2b converts the IF signal into a base band analog signal, and the BS processing unit 2c converts the base band analog signal into a digital signal.

In addition, the above-described signal processing is reversed when a signal is transmitted from the BS 2 to the MS 1, and its detailed description will be abridged.

As described above, the RF processing unit 1a, the IF processing unit 1b and the BS processing unit 1c of the MS 1 respectively include a transmitter and a receiver (not shown) in FIG. 1), and the RF processing unit 2a, the IF processing unit 2b and the BS processing unit 2c of the BS 2 respectively include a transmitter and a receiver (not shown in FIG. 1).

The present invention considers a reception unit for receiving signals, and in particular to a CDMA (code division multiple access) receiver.

In FIG. 1, a general CDMA receiver includes receivers of the IF processing unit 1b and the BS processing unit 1c of the BS 1 and receivers of the IF processing unit 2b and the BS processing unit 3c of the BS 2.

FIG. 2 illustrates a construction of the conventional CDMA analog receiver.

As depicted in FIG. 2, the conventional CDMA analog receiver includes a gain controller 10 controlling an amplitude of an analog IF signal according to an analog automatic gain control signal, a CDMA demodulator 20 demodulating the analog IF signal gain-controlled in the gain controller 10 into an analog base band signal, a base band pass filter 30 eliminating an image signal generated in demodulating of the analog base band signal, an operational amplifier 40 amplifying an output signal of the base band pass filter 30 at a certain level, an analog-digital converter 50 converting an analog base band signal outputted from the operational amplifier 40 into a digital base band signal, an automatic gain control ROM 60 outputting a digital automatic gain control signal by using an amplitude of the digital base band signal outputted from the analog-digital converter 50, and a digital-analog converter 70 converting the digital automatic gain control signal into the analog automatic gain control signal.

The operation of the conventional CDMA analog receiver will be described in more detail.

When an analog IF (intermediate frequency) signal 9 processed in a RF (radio frequency) processing part of a CDMA system is transmitted to the CDMA analog receiver, in order to maintain a constant amplitude (power) of an input signal 45 of the analog-digital converter 50, the gain controller 10 controls a gain of the analog IF signal 9 according to an analog automatic gain control signal. The CDMA demodulator 20 converts an output signal of the gain controller 10 into a base band I (inphase) signal and a base band Q (quadrature) signal. The base band pass filter 30 eliminates the image signal from the base band I, Q signals, and the operational amplifier 40 amplifies the output signal of the base band pass filter 30 so as to have a certain level.

The analog-digital converter 50 converts the analog base band signal 45 outputted from the operational amplifier 40 into a digital base band CDMA signal and outputs it.

The operation of the analog-digital converter 50 will be described with reference to accompanying FIG. 3.

As depicted in FIG. 3, when a level of the input signal 45 of the analog-digital converter 50 is between a first threshold value and a second threshold value, the analog-digital converter 50 outputs a digital value corresponding to the level of the input signal 45. In addition, when a level of the input signal 45 is not between the first threshold value and the second threshold value, the analog-digital converter 50 outputs a digital value corresponding to a limit value of an input range in order to prevent a signal distortion.

For example, when a first threshold value of the analog-digital converter 50 is 0V and a second threshold value of the analog-digital converter 50 is 1V, the analog-digital converter 50 converts an analog signal of 0˜1 volt (within the input range) outputted from the operational amplifier 40 into a pertinent digital value. When an analog signal of −0.1 V (out of the input range) is inputted, the analog-digital converter 50 outputs ‘0’ value, when an analog signal of 1.1 V (out of the input range) is inputted, the analog-digital converter 50 outputs ‘1’ value.

The automatic gain control ROM 60 receives the digital value converted in the analog-digital converter 50 and outputs a digital automatic gain control signal so as to have a maximum SNR (signal noise ratio). The digital-analog converter 70 coverts the digital automatic gain control signal into an analog automatic gain control signal and outputs it to the gain controller 10. The gain controller 10 maintains an input power of the analog-digital converter 50 at a certain level by controlling a gain of the analog IF signal 9 according to the analog automatic gain control signal.

In the conventional CDMA analog receiver, an inputted analog IF signal is gain-controlled in the gain controller 10, converted into a digital base band signal, and a gain of the analog IF signal is controlled in the automatic gain control ROM 60. As described above, the conventional automatic gain control ROM 60 is constructed so as to provide optimum functions for a CDMA analog receiver.

However, with a recent trend in a mobile communication system toward high performance, broadband and microminiaturization, digital and module type high frequency CDMA parts are requested. In addition, converting a CDMA analog receiver into a CDMA digital receiver is requested. And, when the CDMA analog receiver is converted into the CDMA digital receiver, because an input signal of the automatic gain controller is varied, different automatic gain control is performed about the same input signal (analog IF signal).

In addition, because different automatic gain control is performed in the CDMA digital receiver and the automatic gain controller is the most suitable controller for the CDMA analog receiver, it can not be used for the CDMA digital receiver as it is.

### SUMMARY OF THE INVENTION

An object of the invention is to solve at least the above problems and/or disadvantages and to provide at least the advantages described hereinafter.

It is a particular object of the present invention to provide a CDMA digital receiver implemented by digial logic.

When a CDMA (code division multiple access) analog receiver is converted into a CDMA digital receiver and used in a CDMA system, it is another object of the present invention to provide a CDMA (code division multiple access) digital receiver and an automatic gain control method thereof which is capable of performing the same automatic gain control as the CDMA analog receiver about the same input signal (analog IF signal).

When a CDMA (code division multiple access) analog receiver is converted into a CDMA digital receiver and used in a CDMA system, it is yet another object of the present invention to provide a CDMA (code division multiple access) digital receiver and an automatic gain control method thereof which is capable of using an automatic gain controller used for the CDMA analog receiver as it is.

In order to achieve the above-mentioned objects, a CDMA (code division multiple access) digital receiver in accordance with the present invention includes an analog/digital converter for converting an analog IF (intermediate frequency) signal into a digital IF signal and a digital logic for converting the digital IF signal into a digital base band signal.

A CDMA (code division multiple access) digital receiver in accordance with the present invention includes a gain controller for controlling an amplitude of an inputted analog IF (intermediate frequency) signal according to an analog automatic gain control signal, an operational amplifier for amplifying the analog IF signal gain-controlled in the gain controller so a to have a certain level; an analog-digital converter for converting the analog IF signal outputted from the operational amplifier into a digital IF signal, a digital logic for outputting a digital base band CDMA signal by using the digital IF signal outputted form the analog-digital converter and generating a digital automatic gain control signal corresponded to the digital IF signal, and a digital-analog converter for converting the digital automatic gain control signal generated in the digital logic into the analog automatic gain control signal.

An automatic gain control unit of a CDMA (code division multiple access) digital receiver in accordance with the present invention includes a digital demodulator for demodulating a digital IF (intermediate frequency) signal into a digital base band signal, a digital base band pass filter for eliminating an image signal generated in demodulating of the digital base band signal, a digital clipper for restoring the digital base band signal outputted from the digital base band pass filter so as to have a certain level, and an automatic gain control ROM for outputting a digital automatic gain control signal by using an output signal of the digital clipper so as to have a maximum SNR (signal noise ratio).

A reception method of a CDMA digital receiver in accordance with the present invention includes converting a CDMA analog IF (intermediate frequency) signal into a digital IF signal, and outputting a digital base band CDMA signal by using the digital IF signal.

An automatic gain control method of a CDMA digital receiver in accordance with the present invention includes controlling a gain of a CDMA analog IF signal according to an analog automatic gain control signal, converting the gain-controller analog IF signal into a digital IF signal, outputting the digital IF signal as a digital base band signal after digital-demodulating it, clipping the demodulated digital base band signal so as to have a certain level, outputting a digital automatic gain control signal by using the level of the clipped signal so as to have a maximum SNR, and converting the digital automatic gain control signal into the analog automatic gain control signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a construction of a general CDMA system;

FIG. 2 illustrates a construction of the conventional CDMA analog receiver;

FIG. 3 illustrates operation characteristics of the conventional analog-digital converter;

FIG. 4 illustrates a construction of a CDMA digital receiver in accordance with a preferred embodiment of the present invention;

FIG. 5 is a flow chart illustrating an operation of the CDMA digital receiver in accordance with a preferred embodiment of the present invention;

FIG. 6 illustrates input/output signals of an analog-digital converter in accordance with a preferred embodiment of the present invention;

FIG. 7a illustrates an input signal of a digital clipper in accordance with a preferred embodiment of the present invention; and

FIG. 7b illustrates an output signal of a digital clipper in accordance with a preferred embodiment of the present invention.

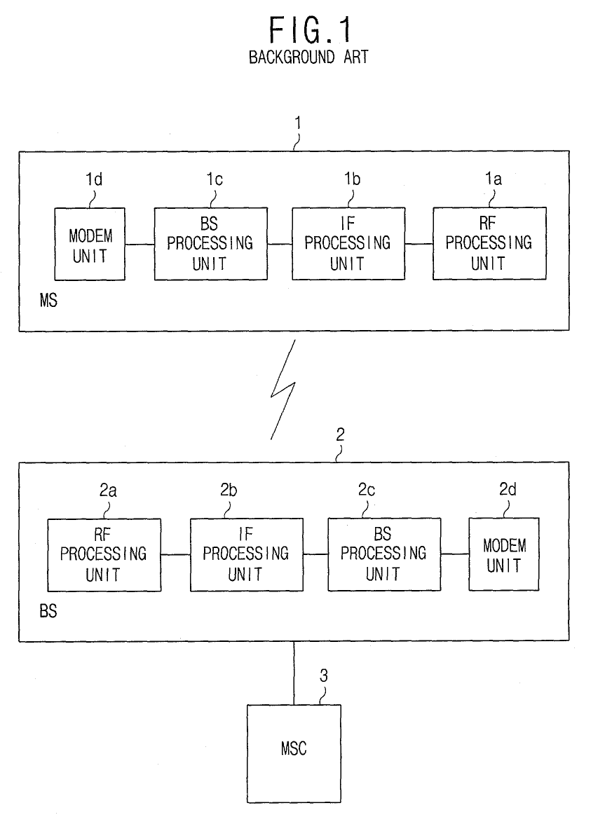

### DETAILED DESCRIPTION OF PREFERRED EMBODIMENTS

Hereinafter, the preferred embodiment of the present invention will be described with reference to accompanying drawings.

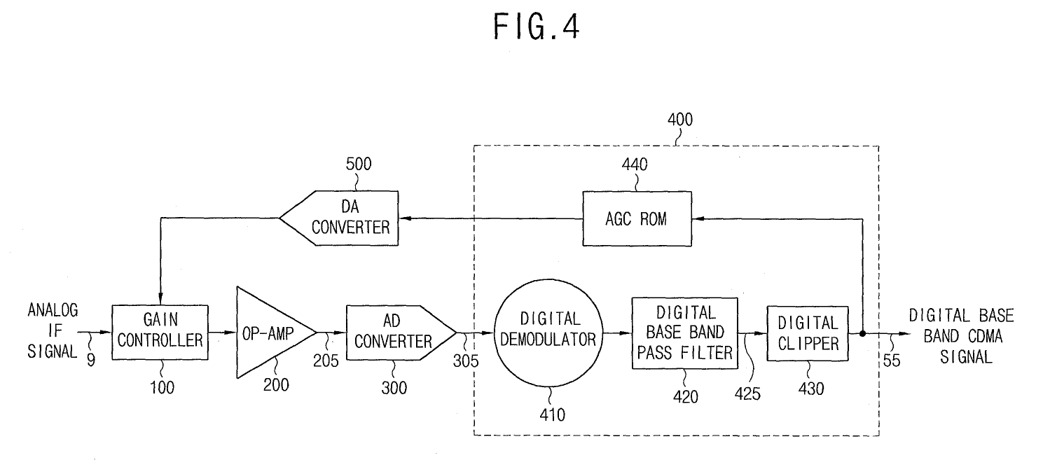

First, FIG. 4 illustrates a construction of a CDMA digital receiver in accordance with an embodiment of the present invention.

As depicted in FIG. 4, a CDMA (code division multiple access) digital receiver in accordance with the present invention includes a gain controller 100 controlling an amplitude of an input signal (analog IF signal) according to an analog automatic gain control signal, an operational amplifier 200 amplifying the analog IF signal gain-controlled in the gain controller 100 so as to have a certain level, an analog-digital converter 300 converting the analog IF signal 205 outputted from the operational amplifier 200 into a digital IF signal, a digital logic unit 400 outputting a digital base band CDMA signal by using the digital IF signal outputted from the analog-digital converter 300 and generating a digital automatic gain control signal corresponding to the digital IF signal, and a digital-analog converter 500 converting the digital automatic gain control signal generated in the digital logic unit 400 into an analog automatic gain control signal.

The digital logic unit 400 includes a digital demodulator 410 demodulating the digital IF signal outputted from the analog-digital converter 300 into a digital base band signal, a digital base band pass filter 420 eliminating an image signal generated in demodulating of the digital base band signal in the digital demodulator 410, a digital clipper 430 restoring the signal 525 outputted from the digital base band pass filter 420 into a certain level and outputting a digital base band CDMA signal, and an automatic gain control ROM 440 outputting a digital automatic gain control signal by using the output signal of the digital clipper 430. The certain level, to which the digital clipper restores signal 425, is a level of a digital base band CDMA signal outputted from the conventional CDMA analog receiver, namely, a level of a digital base band CDMA signal set in a BS processing unit of a general CDMA system.

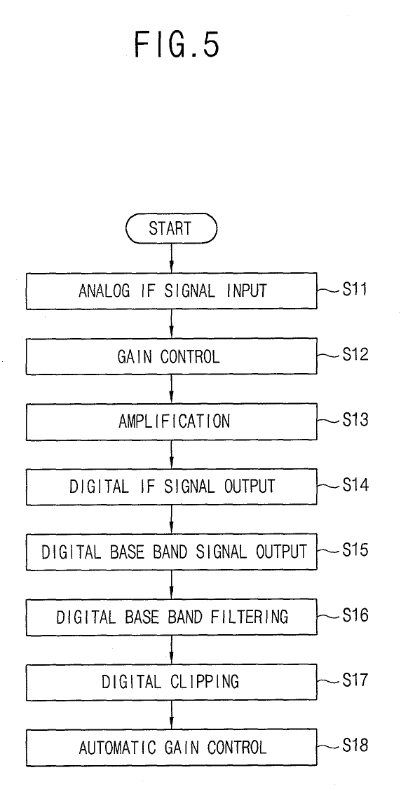

The operation of the CDMA digital receiver in accordance with the embodiment of the present invention will be described with reference to accompanying FIG. 5.

The CDMA digital receiver converts an analog IF signal into a digital IF signal, converts the digital IF signal into a digital base band signal and clips the digital base band signal. And, the CDMA digital receiver performs the same automatic gain control as the CDMA analog receiver by using the clipped digital base band signal.

It will be described in more detail.

When an analog IF signal 9 processed in a RF processing part of the CDMA system is inputted to the CDMA digital receiver 11 as shown at step S11, in order to maintain an amplitude (power) of an input signal 205 of the analog-digital converter 300, the gain controller 100 controls a gain of the analog IF signal 9 according to an analog automatic gain control signal as shown at step S12. The operational amplifier 200 amplifies the analog IF signal gain-controlled in the gain controller 100 so as to have a certain level as shown at step S13.

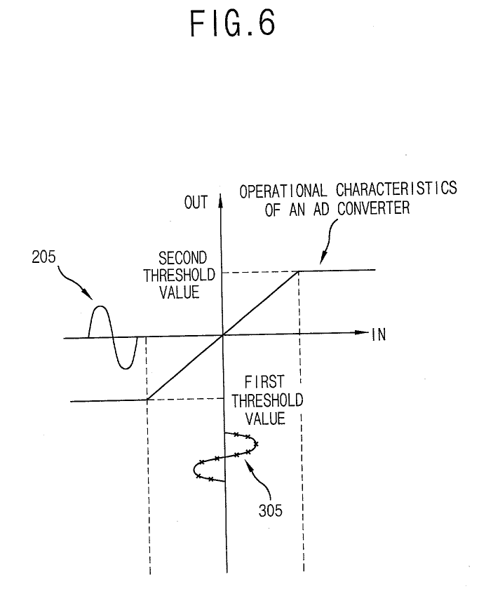

The analog-digital converter 300 converts the analog IF signal amplified in the operational amplifier 200 into a digital IF signal 305. As depicted in FIG. 6, the analog IF signal 205 is maintained so as to reside within an input range of the analog-digital converter 300 by the gain control of the gain controller 100, and the analog-digital converter 300 outputs a digital IF signal 305 corresponding to the inputted analog IF signal 205. Herein, when the analog IF signal 205 out of the input range of the analog-digital converter 300 is inputted (not shown in FIG. 6), the analog-digital converter 300 outputs a pertinent limit value of the input range by the conventional method as shown at step S14.

The digital IF signal 305 is inputted to the digital logic unit 400, wherein the digital demodulator 410 outputs digital base band signals (I, Q signals) by digital-demodulating the digital IF signal 305 as shown in step S15. The digital base band pass filter 420 eliminates an image signal generated in demodulating the digital base band signal as shown at step S16.

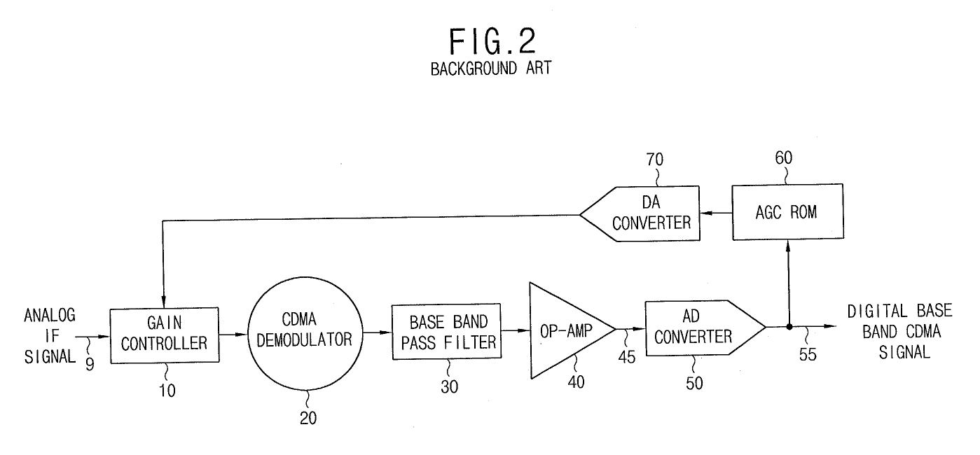

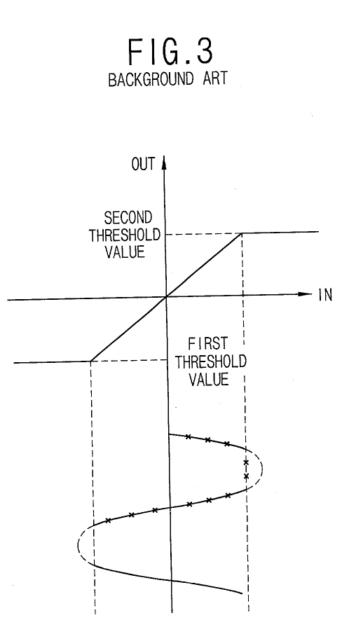

An amplitude of the output signal 425 of the digital base band pass filter 420 is different from the amplitude of the digital base band CDMA signal as an output signal of the conventional analog receiver. In more detail, an amplitude of the signal 425 generated by converting the analog IF signal into the digital IF signal and digital-demodulating it is different from an amplitude of a signal generated by analog-demodulating an analog IF signal and converting it into a digital base band signal (output signal 55 shown at FIG. 2). The conventional analog-digital converter 50 outputs a pertinent digital value which corresponds to an input range without regard to whether or not the input signal 45 is placed within an input range of analog/digital converter 50. Accordingly, the output signal of the conventional analog-digital converter 50 is placed within a level range of a digital base band signal preset in the CDMA system. In the present invention, the analog-digital converter 300 is operated by the conventional method. However a digital demodulating process is performed after performing a converting process of the analog-digital converter 300. Therefore, it is possible that the digital base band signal 425 generated in accordance with the present invention can be placed out of the level range of the digital base band signal preset in the CDMA system.

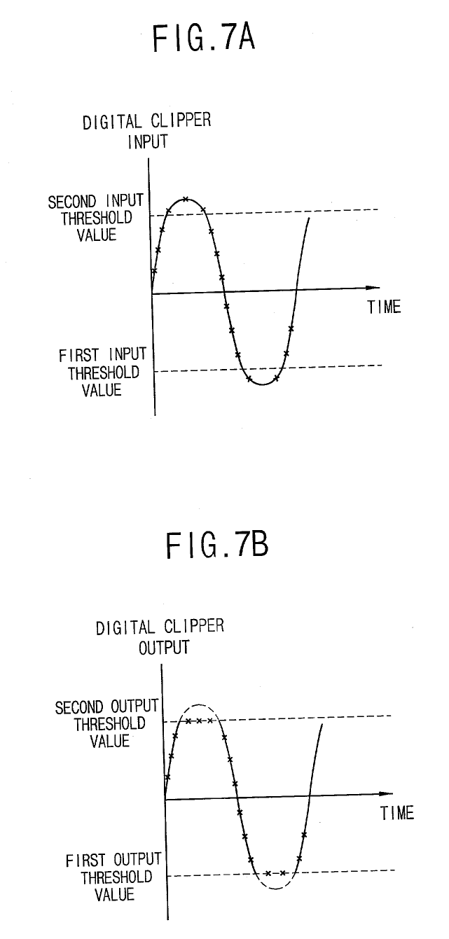

In the present invention, the digital clipper 430 is implemented after the digital base band pass filter 420 to compensate for this effect. As shown in FIG. 7a, first and second input threshold values of the digital clipper 430 are set according to a level range of the digital base band signal preset in the CDMA system. As a result, when the digital base band signal 425 lies outside of the first input threshold value the digital clipper outputs the first output threshold value, as shown in FIG. 7b. And, when the digital base band signal 425 lies outside the second input threshold value, the digital clipper outputs the second output threshold value, as further shown in FIG. 7b. From FIGS. 7a and 7b, it is therefore evident that digital clipper 430 clips the inputted signal 425 according to pertinent threshold values. Therefore, when the analog IF signal is inputted to the conventional CDMA analog receiver, the signal 55 outputted form the digital clipper 430 has the same amplitude as an amplitude of a signal outputted when the analog IF signal is inputted to the conventional CDMA analog receiver. More specifically, the output signal of the digital clipper 430 is outputted as a signal level preset according to a predetermined recommendation as shown at step S17.

In addition, the digital base band signal clipped in the digital clipper 430 is provided to the automatic gain control ROM 440. The automatic gain control ROM 440 is operated by the same method as the conventional analog receiver and outputs a digital automatic gain control signal so as to have a maximum SNR as shown at step S18. The digital-analog converter 500 converts the digital automatic gain control signal outputted form the automatic gain control ROM 440 into an analog automatic gain control signal and provides it to the gain controller 100. Because the digital logic 400 digitally demodulates the digital base band signal and then clips the digital-demodulated base band signal, the invention advantageously may perform the same automatic gain control as is performed by a conventional CDMA analog receiver.

In summary, when a RF-processed CDMA analog IF signal is inputted, the present invention converts the analog IF signal into a digital IF signal, digitally demodulates it to produce a digital base band signal, then clips the digital-demodulated base band signal so as to have a certain level, which, for example, may match a level of a baseband signal output from a conventional CDMA receiver. Accordingly, performance of a receiver can be improved.

In addition, when a CDMA analog receiver is converted into a CDMA digital receiver, the same signal as an input signal of the CDMA analog receiver is inputted to the CDMA digital receiver, and a digital base band CDMA signal at the same level as the output signal of the CDMA analog receiver is outputted. Accordingly it is possible to use common units. And, by performing an automatic gain control in the CDMA analog receiver and the CDMA digital receiver by the same method, an automatic gain controller used in the CDMA analog receiver can be used for the CDMA digital receiver as it is.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A CDMA (code division multiple access) digital receiver, comprising:
an analog/digital converter for converting an analog IF (intermediate frequency) signal into a digital IF signal; and
a digital logic unit for converting the digital IF signal into a digital base band signal.

2. The CDMA digital receiver of claim 1, further comprising:
a gain controller for controlling a gain of the analog IF signal;
an operational amplifier for amplifying the gain-controlled analog IF signal and outputting it to the analog/digital converter; and
a digital/analog converter for controlling the gain controller by converting a digital automatic gain control signal output from the digital logic unit into an analog automatic gain control signal.

3. The CDMA digital receiver of claim 1, wherein the digital logic includes:
a digital demodulator for demodulating the digital IF signal output from the analog/digital converter into the digital base band signal;
a digital base band pass filter for eliminating an image signal from the digital base band signal;
a digital clipper for clipping the digital base band signal so as to have a certain level; and
an automatic gain control ROM for performing automatic gain control by using the clipped digital base band signal.

4. The CDMA digital receiver of claim 3, wherein the certain level is a level of a digital base band CDMA signal which is generally set in a CDMA system.

5. A CDMA (code division multiple access) digital receiver, comprising:
a gain controller for controlling an amplitude of an analog IF (intermediate frequency) signal according to an analog automatic gain control signal;
an operational amplifier for amplifying the gain-controlled analog IF signal output from the gain controller so as to have a certain level;
an analog-digital converter for converting the analog IF signal output from the operational amplifier into a digital IF signal;
a digital logic for outputting a digital base band CDMA signal using the digital IF signal outputted form the analog-digital converter, and for generating a digital automatic gain control signal corresponding to the digital IF signal; and
a digital-analog converter for converting the digital automatic gain control signal generated in the digital logic into the analog automatic gain control signal.

6. The CDMA digital receiver of claim 5, wherein the digital logic includes:
a digital demodulator for demodulating the digital IF signal output from the analog-digital converter into the digital base band signal;
a digital base band pass filter for eliminating an image signal generated in demodulating of the digital base band signal in the digital demodulator;
a digital clipper for restoring a signal output from the digital base band pass filter so as to have a certain level; and
an automatic gain control ROM for outputting a digital automatic gain control signal based on an output signal of the digital clipper so as to have a maximum SNR (signal noise ratio).

7. The CDMA digital receiver of claim 6, wherein the certain level is a level of a digital base band CDMA signal set in a base band signal processing part of a CDMA system.

8. An automatic gain control unit of a CDMA (code division multiple access) digital receiver, comprising:
a digital demodulator for demodulating a digital IF (intermediate frequency) signal into a digital base band signal;
a digital base band pass filter for eliminating an image signal generated in demodulating of the digital base band signal;
a digital clipper for restoring the digital base band signal output from the digital base band pass filter so as to have a certain level; and
an automatic gain control ROM for outputting a digital automatic gain control signal based on an output signal of the digital clipper so as to have a maximum SNR (signal noise ratio).

9. The unit of claim 8, wherein the certain level is a level of a digital base band CDMA signal preset in a CDMA system.

10. A reception method of a CDMA digital receiver, comprising:
converting a CDMA analog IF (intermediate frequency) signal into a digital IF signal; and
outputting a digital base band CDMA signal by using the digital IF signal.

11. The method of claim 10, wherein the converting step includes the sub-steps of:
controlling a gain of the CDMA analog IF signal;
amplifying the gain-controlled analog IF signal so as to have a certain level; and
converting the amplified analog IF signal into a digital IF signal.

12. The method of claim 10, wherein the outputting step includes the sub-steps of:
outputting a digital base band signal by digital-demodulating the digital IF signal;
eliminating an image signal from the demodulated digital base band signal;
clipping the image signal-eliminated digital base band signal; and
performing a digital automatic gain control based on the clipped digital base band signal.

13. The method of claim 12, wherein the clipping is restoring a level of the digital base band signal into a level of a digital base band CDMA signal which is generally set in a CDMA system.

14. An automatic gain control method of a CDMA digital receiver, comprising:
controlling a gain of a CDMA analog IF signal according to an analog automatic gain control signal;
converting the gain-controlled analog IF signal into a digital IF signal;
outputting the digital IF signal as a digital base band signal after digital-demodulating it;
clipping the demodulated digital base band signal so as to have a certain level;
outputting a digital automatic gain control signal by using the level of the clipped signal so as to have a maximum SNR; and
converting the digital automatic gain control signal into the analog automatic gain control signal.

15. The method of claim 14, wherein a gain of the analog IF signal is controlled in order to maintain a constant power of the signal to be digital-converted.

16. The method of claim 14, wherein the certain level is a level of a digital base band CDMA signal which is generally set in the CDMA system.

17. A CDMA digital receiver, comprising:
an A/D converter which converts an analog IF signal into a digital IF signal; and
a digital demodulator which demodulates the digital IF signal to produce a digital base band signal.

18. The CDMA digital receiver of claim 17, further comprising:
a digital clipper which adjusts a level of the digital base band signal to lie within a predetermined range.

19. The CDMA digital receiver of claim 18, wherein said predetermined range is an operating range of the CDMA receiver.

20. The CDMA digital receiver of claim 19, wherein if the level of the digital base band signal lies outside of said predetermined range, the digital clipper adjusts the level of the digital base band signal to a threshold value.

21. The CDMA digital receiver of claim 17, further comprising:
an automatic gain control (AGC) unit which adjusts a gain of a received analog IF signal input into the CDMA receiver and outputs a gain-controlled signal to said A/D converter.

22. The CDMA digital receiver of claim 21, further comprising:
an AGC control unit which controls the AGC unit to adjust the gain of said received analog IF signal based on a level of the digital base band signal.

23. The CDMA digital receiver of claim 18, further comprising:
an automatic gain control (AGC) unit which adjusts a gain of a received analog IF signal input into the CDMA receiver, and which outputs a gain-controlled signal to said A/D converter.

24. The CDMA digital receiver of claim 23, further comprising:
an AGC control unit which controls the AGC unit to adjust the gain of said received analog IF signal based on a level of an output of the digital clipper.

25. A digital demodulation system, comprising:
a digital demodulator which demodulates a digital IF signal to produce a digital base band signal, said digital demodulator included within a CDMA receiver.

26. The digital demodulation system of claim 25, further comprising:
an AGC control unit which detects a level of the digital base band signal and outputs a gain-control signal for controlling a gain of an analog IF signal input into the CDMA receiver.

27. The digital demodulation system of claim 26, wherein the gain-control signal output from the AGC control unit is a digital signal.

28. The digital demodulation system of claim 25, further comprising:
a digital clipper which adjusts a level of the digital base band signal to lie within a predetermined range.

29. The digital demodulation system of claim 28, wherein said predetermined range is an operating range of the CDMA receiver.

30. The digital demodulation system of claim 29, wherein if the level of the digital base band signal lies outside of said predetermined range, the digital clipper adjusts the level of the digital base band signal to a threshold value.

31. The digital demodulation system of claim 28, further comprising:
an AGC control unit which detects a level of a signal output from the digital clipper and outputs a gain-control signal for controlling a gain of an analog IF signal input into the CDMA receiver.

32. The digital demodulation system of claim 31, wherein the gain-control signal output from the AGC control unit is a digital signal.

33. A method for demodulating a signal in a CDMA receiver, comprising:
converting an analog IF signal into a digital IF signal; and
demodulating the digital IF signal to produce a digital base band signal.

34. The method of claim 33, further comprising:
clipping a level of the digital base band signal to lie within a predetermined range.

35. The method of claim 34, wherein said predetermined range is an operating range of the CDMA receiver.

36. The method of claim 35, wherein if the level of the digital base band signal lies outside of said predetermined range, said clipping step adjusts the level of the digital base band signal to a threshold value.

37. The method of claim 33, further comprising:
adjusting a gain of a received analog IF signal input into the CDMA receiver; and
outputting a gain-controlled signal to an A/D converter which performs said converting step.

38. The method of claim 21, wherein said adjusting step includes:
adjusting the gain of said received analog IF signal based on a level of the digital base band signal.

39. The method of claim 34, wherein said adjusting step includes:
adjusting a gain of a received analog IF signal input into the CDMA receiver, said adjusting step being performed based on a level of the clipped signal generated by said clipping step; and
outputting a gain-controlled signal to an A/D converter which performs said converting step.
